(19) United States
(12) Patent Application Publication
(10) Pub. No.: US 2026/0200234 A1
(43) Pub. Date: Jul. 16, 2026

(54) LIQUID BOTTLE INCLUDING VALVE THAT IS CONFIGURED TO CONTACT LIP OF RUBBER AND THAT HAS PROTRUDING PORTION CONFIGURED TO BE LOCATED INWARD OF THE LIP OF RUBBER

(71) Applicant: BROTHER KOGYO KABUSHIKI KAISHA, Nagoya (JP)

(72) Inventors: Masahiro HAYASHI, Anjo (JP); Fumiya NAKAMURA, Nagoya (JP); Yuma TANABE, Nagoya (JP); Naoya OKAZAKI, Hashima (JP); Satoru OKI, Nagoya (JP); Yuji FUKUTA, Nagoya (JP)

(73) Assignee: BROTHER KOGYO KABUSHIKI KAISHA, Nagoya (JP)

(21) Appl. No.: 19/560,773

(22) Filed: Mar. 9, 2026

Related U.S. Application Data
(63) Continuation of application No. PCT/JP2024/029974, filed on Aug. 23, 2024.

(30) Foreign Application Priority Data
Sep. 11, 2023 (JP) 2023-147030

(51) Int. Cl. B41J 2/175; B67D 7/02

(52) U.S. Cl. CPC B41J 2/17509; B41J 2/17596; B67D 7/0294

(57) ABSTRACT

A liquid bottle includes a body, a rubber, a valve, and a resilient member urging the valve toward the rubber. The body has an internal space and an opening through which the internal space is configured to communicate with an outside of the body. The rubber is positioned at the opening. The rubber has a first lip extending into the internal space around the opening. The valve is configured to contact the first lip. The first lip has an annular shape whose first length in a first direction is longer than a second length thereof in a second direction orthogonal to the first direction. The valve has a flat portion and a protruding portion. The flat portion opposes the first lip in an urging direction of the resilient member. The protruding portion protrudes from the flat portion and is positioned inward of the first lip.

### REFERENCE TO RELATED APPLICATIONS

This is a by-pass continuation application of International Application No. PCT/JP2024/029974 filed August 23, 2024 which claims priority from Japanese Patent Application No. 2023-147030 filed September 11, 2023. The entire contents of the International Application and the priority application are incorporated herein by reference.

### BACKGROUND ART

There has been known a liquid bottle connectable to an ink tank. The liquid bottle has a supply opening. In an internal space of the liquid bottle, positioned are a valve, a coil spring, and a seal. By the valve urged by the coil spring contacting the seal, the supply opening is closed.

### SUMMARY

In a seal, a lip may be located at a position on which a valve abuts. In a case where a liquid bottle has an elongated supply opening or a plurality of supply openings, an elongated lip may be positioned in the seal. When the lip has an elongated shape, the lip may have a portion whose strength is weaker than other portions. As such, the lip may bend or deform when contacted by the valve, possibly resulting in decrease in surface pressure which is necessary for sealing.

In view of the foregoing, it is an object of the present disclosure to provide a liquid bottle which can restrict deformation of a lip of a rubber on which a valve is configured to abut.

In order to attain the above and other object, according to one aspect, the present disclosure provides a liquid bottle including a body, a rubber, a valve, and a resilient member. The body has an internal space and an opening. The opening allows the internal space to communicate with an outside of the body through the opening. The rubber is positioned at the opening of the body. The rubber has a first lip extending into the internal space around the opening. The valve is configured to contact the first lip. The resilient member urges the valve toward the rubber. The first lip has an annular shape having a first length in a first direction and a second length in a second direction orthogonal to the first direction, the first length being longer than the second length. The valve has a flat portion and a protruding portion. The flat portion opposes the first lip in an urging direction of the resilient member. The protruding portion protrudes from the flat portion and is configured to be located inward of the first lip.

In the liquid bottle with the above-described configuration, the valve is configured to contact and separate from the rubber. When the valve separates from the rubber, liquid can flow out from the internal space toward the outside through the opening. Since the protruding portion is positioned inward of the first lip while either the flat portion or the protruding portion is in contact with the first lip, the first lip is restricted from deforming to bend inward, thereby providing liquid-tight sealing to the opening of the body. Further, since the protruding portion is positioned inward of the first lip, a volume of a space in which ink can be accumulated on the inside of the first lip can be reduced.

According to another aspect, the present disclosure also provides a liquid bottle including a body, a rubber, a valve, and a resilient member. The body has an internal space and a first opening. The first opening allows the internal space to communicate with an outside of the body through the first opening. The rubber is positioned at the first opening of the body. The rubber has: a first lip extending into the internal space around the first opening; and a second lip positioned inward of the first lip, the second lip extending into the internal space around the first opening. The valve is configured to contact both the first lip and the second lip. The resilient member urges the valve toward the rubber. The first lip has an annular shape having a first length in a first direction and a second length in a second direction orthogonal to the first direction, the first length being longer than the second length.

With this structure, deformation of the first lip of the rubber, on which the valve is configured to abut, can be restricted.

### BRIEF DESCRIPTION OF DRAWINGS

FIG. 1 is an external perspective view of a multifunction peripheral 10.

FIG. 2 is a vertical cross-sectional view schematically illustrating an internal structure of a printer portion 11.

FIG. 3 is a plan view illustrating arrangement of a carriage 23 and an ink tank 100.

FIG. 4 is a perspective view of an ink tank set 51.

FIG. 5 is a perspective view of the ink tank 100.

FIG. 6 is a vertical cross-sectional view of the ink tank set 51.

FIG. 7 is a perspective view of a liquid bottle 80.

FIG. 8 is a schematic view illustrating an outer shape of a protrusion 94.

FIG. 9 is a perspective view of a rubber 83.

FIG. 10 is another perspective view of the rubber 83.

FIG. 11 is a perspective view of a support member 84.

FIG. 12 is another perspective view of the support member 84.

FIG. 13 is a perspective view of a valve 161.

FIG. 14 is a vertical cross-sectional view of the liquid bottle 80 while the valve 161 is in a closing position.

FIG. 15 is a vertical cross-sectional view of the liquid bottle 80 while the valve 161 is in an opening position.

FIG. 16 is a vertical cross-sectional view illustrating a state where the liquid bottle 80 is connected to the ink tank set 51.

FIG. 17A is a perspective view of a tank tube 131.

FIG. 17B is a perspective view illustrating a modification to the liquid bottle 80.

FIG. 18 is a perspective view illustrating another modification to the liquid bottle 80.

FIG. 19 is a schematic view illustrating a protrusion 94 according to a modification.

FIG. 20 is a schematic view illustrating a protrusion 94 according to another modification.

FIG. 21 is a schematic view illustrating a protrusion 94 according to still another modification.

### DESCRIPTION

Hereinafter, an embodiment of the present disclosure will be described while referring to accompanying drawings. Incidentally, the embodiments described below are merely illustrative examples of the present disclosure, and it would be obvious that various modifications may be made to the embodiments of the present disclosure without departing from the technical concept of the present disclosure. Further, in the following description, each arrow advancing from an origin to an end point thereof represents one component of its corresponding direction, and each bidirectional arrow contains two opposite directions. Specifically, an upward direction and a downward direction are each one component of an up-down direction and are opposite each other. A leftward direction and a rightward direction are each one component of a left-right direction, and are opposite each other. Likewise, a frontward direction and a rearward direction are each one component of a front-rear direction, and are opposite each other. In the present embodiment, the up-down direction corresponds to a vertical direction, and the front-rear direction and the left-right direction both correspond to horizontal directions.

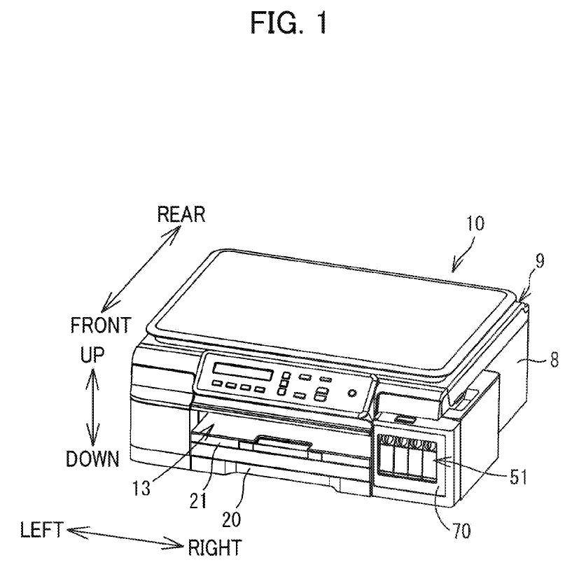

Further, the up-down direction will be defined assuming that a multifunction peripheral 10 is placed in an operable state or posture. The front-rear direction will be defined assuming that the side of the multifunction peripheral 10 at which an opening 13 is arranged is defined as the near side, and the left-right direction will be defined based on a perspective of a user facing the near side of the multifunction peripheral 10. Incidentally, the state depicted in FIG. 1 may be referred to as “operational state”. Further, the posture depicted in FIG. 1 may be referred to as “operational posture”. The near side of the multifunction peripheral 10 on which the opening 13 is arranged will be referred to as the front side.

### Overall Configuration of Multifunction Peripheral 10

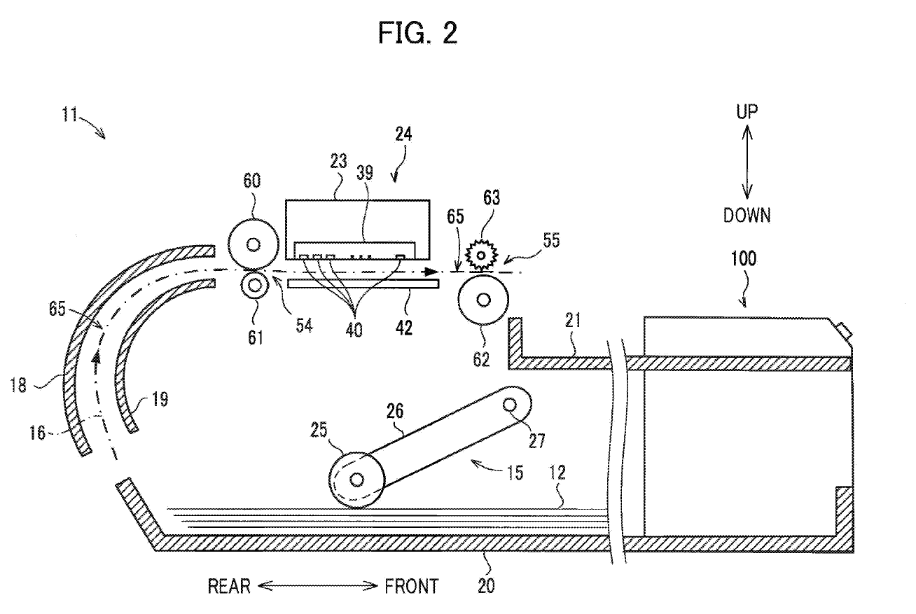

As illustrated in FIG. 1, the multifunction peripheral 10 includes a casing 8 having a substantially rectangular parallelepiped. The multifunction peripheral 10 includes a scanner portion 9 and a printer portion 11 in an internal space of the casing 8. The scanner portion 9 is positioned at an upper portion in the internal space of the casing 8. The scanner portion 9 has a scanning function. The printer portion 11 is positioned below the scanner portion 9 in the internal space of the casing 8. The printer portion 11 has a printing function. The printer portion 11 is configured to record an image on a sheet 12 illustrated in FIG. 2 in accordance with an inkjet recording method. As illustrated in FIG. 2, the printer portion 11 includes a feeding unit 15, a sheet tray 20, a discharge tray 21, a conveying path 65, a feed roller unit 54, a recording unit 24, a discharge roller unit 55, a platen 42, and an ink tank set 51.

### Sheet Tray 20, Discharge Tray 21

As illustrated in FIG. 1, the opening 13 is positioned on the front surface of the multifunction peripheral 10 at a center portion thereof in the left-right direction. The sheet tray 20 is configured to move in the front-rear direction through the opening 13 by user’s operations. As illustrated in FIG. 2, the sheet tray 20 is configured to support a plurality of the sheets 12 in a stacked state. The discharge tray 21 is positioned above the sheet tray 20. The discharge tray 21 is configured to move in the front-rear direction together with the sheet tray 20. The discharge tray 21 is configured to support the sheets 12 discharged by the discharge roller unit 55.

### Feeding Unit 15

The feeding unit 15 is configured to feed the sheets 12 supported on the sheet tray 20 onto the conveying path 65. As illustrated in FIG. 2, the feeding unit 15 includes a feeding roller 25, a feeding arm 26, and a shaft 27. The feeding roller 25 is rotatably supported by a free end portion of the feeding arm 26. The feeding roller 25 is configured to rotate to convey the sheet 12 in a conveying direction 16 in response to receiving a driving force of a non-illustrated conveying motor. Hereinafter, rotations of a conveying roller 60 and a discharging roller 62 to convey the sheet 12 in the conveying direction 16 will be referred to as “forward rotation.” The feeding arm 26 is pivotably movably supported by the shaft 27 that is supported by a frame of the printer portion 11. The feeding arm 26 is urged, by its own weight or by a resiliently urging force of a spring and the like, such that the feeding arm 26 is pivotable toward the sheet tray 20.

### Conveying Path 65

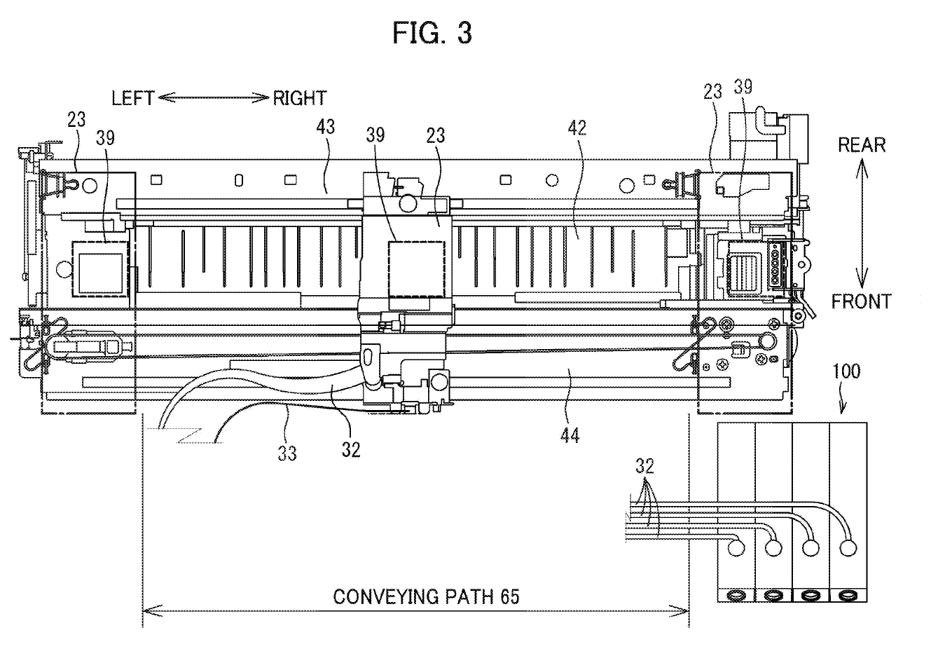

As illustrated in FIG. 2, the conveying path 65 is a space defined by, for example, an outer guide member 18 and an inner guide member 19 opposing each other with a prescribed gap therebetween. The conveying path 65 extends toward the rear of the printer portion 11 from a rear end portion of the sheet tray 20. The conveying path 65 extends upward at the rear of the printer portion 11 while making a U-turn, passes through a space between the recording unit 24 and the platen 42, and reaches the discharge tray 21. As illustrated in FIGS. 2 and 3, a portion of the conveying path 65 between the feed roller unit 54 and the discharge roller unit 55 is positioned substantially at a center portion of the multifunction peripheral 10 in the left-right direction and extends in the front-rear direction. The conveying direction 16 for each sheet 12 in the conveying path 65 is indicated by a dotted-chain-line arrow in FIG. 2.

### Feed Roller Unit 54

As illustrated in FIG. 2, the feed roller unit 54 is positioned upstream relative to the recording unit 24 in the conveying direction 16. The feed roller unit 54 includes the conveying roller 60 and a pinch roller 61. The conveying roller 60 and the pinch roller 61 are arranged to oppose each other in the up-down direction. The conveying roller 60 is configured to rotate in response to receiving of the driving force of the conveying motor. The pinch roller 61 is configured to rotate following the rotation of the conveying roller 60. As the conveying roller 60 rotates forward in response to the forward rotation of the conveying motor, each sheet 12 is configured to be conveyed in the conveying direction 16 while being nipped between the conveying roller 60 and the pinch roller 61.

### Discharge Roller Unit 55

As illustrated in FIG. 2, the discharge roller unit 55 is positioned downstream relative to the recording unit 24 in the conveying direction 16. The discharge roller unit 55 includes the discharging roller 62 and a spur 63. The discharging roller 62 and the spur 63 are arranged to oppose each other in the up-down direction. The discharging roller 62 is configured to rotate in response to receiving the driving force of the conveying motor. The spur 63 is configured to rotate following the rotation of the discharging roller 62. As the discharging roller 62 rotates forward by the forward rotation of the conveying motor, each sheet 12 is configured to be conveyed in the conveying direction 16 while being nipped between the discharging roller 62 and the spur 63.

### Recording Unit 24

As illustrated in FIG. 2, the recording unit 24 is positioned between the feed roller unit 54 and the discharge roller unit 55 in the conveying direction 16. The recording unit 24 is arranged opposite the platen 42 with respect to the conveying path 65 in the up-down direction. The recording unit 24 is positioned above the conveying path 65 in the up-down direction. The recording unit 24 includes a carriage 23 and a recording head 39.

As illustrated in FIG. 3, the carriage 23 is supported by guide rails 43 and 44. The guide rails 43 and 44 are supported by the frame of the printer portion 11. The guide rails 43 and 44 are spaced apart from each other in the front-rear direction and each extend in the left-right direction. The carriage 23 is connected to a well-known belt mechanism disposed at the guide rail 44. The belt mechanism is configured to circularly move in response to receiving a driving force from a non-illustrated carriage motor. As the belt mechanism circularly moves, the carriage 23 is configured to move reciprocatingly in the left-right direction. The carriage 23 is configured to move within a prescribed range which is indicated by one-dotted chain lines in FIG. 3. The carriage 23 is configured to move further rightward and leftward beyond the conveying path 65.

As illustrated in FIG. 3, the recording head 39 is connected to an ink tank 100 through ink tubes 32. The recording head 39 is electrically connected, through a flexible flat cable 33, to a control board on which a non-illustrated controller is surface-mounted. The ink tubes 32 and the flexible flat cable 33 respectively extend from the carriage 23. The ink tubes 32 is configured to supply ink stored in the ink tank 100 to the recording head 39. Specifically, a bundle of the four ink tubes 32 extends from a tank 103 of the refill unit 100 and is connected to the recording head 39. The flexible flat cable 33 is configured to transmit control signals outputted from the controller to the recording head 39.

As illustrated in FIG. 2, the recording head 39 is mounted on the carriage 23. The recording head 39 has a lower surface in which a plurality of nozzles 40 are positioned. The recording head 39 is configured to eject ink as minute ink droplets through the nozzles 40. While the carriage 23 moves, the recording head 39 ejects the ink droplets onto the sheet 12 supported by the platen 42. In this way, an image is recorded on each sheet 12.

### Platen 42

As illustrated in FIGS. 2 and 3, the platen 42 is positioned between the feed roller unit 54 and the discharge roller unit 55 in the conveying direction 16. The platen 42 opposes the recording unit 24 in the up-down direction. The platen 42 supports the sheet 12 conveyed by the feed roller unit 54 from below.

### Ink Tank Set 51

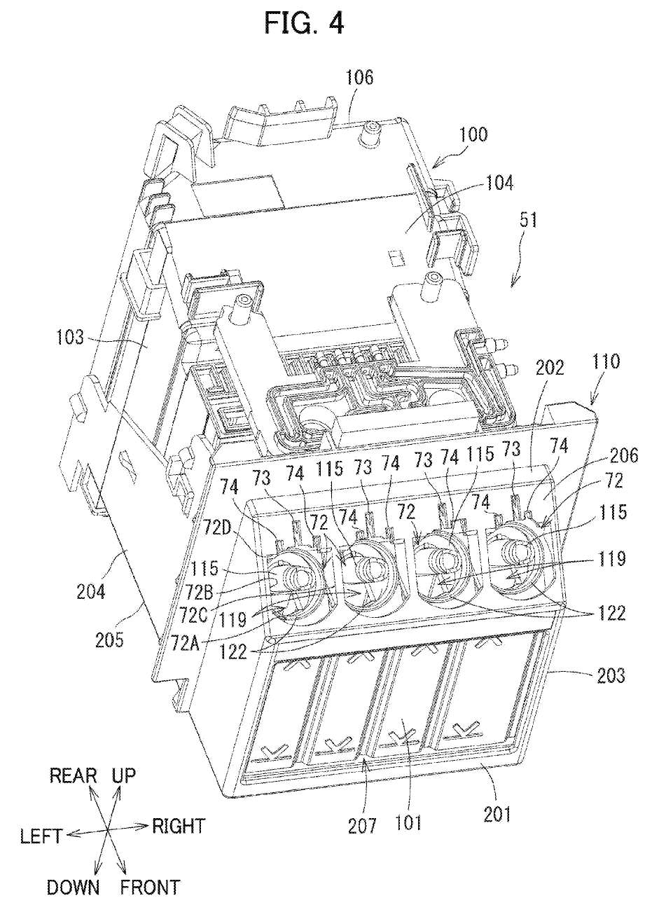

As illustrated in FIG. 4, the ink tank set 51 includes the ink tank 100, a tank cover 110, and tank caps 127. Incidentally, in FIG. 4, the tank caps 127 are omitted. As illustrated in FIG. 1, the 51As illustrated in FIG. 1, the ink tank set 51 is positioned in the interior of the multifunction peripheral 10. The ink tank set 51 is fixed to the multifunction peripheral 10 so that a user cannot remove the ink tank set 51 easily from the multifunction peripheral 10. An opening is positioned on the front surface of the casing 8 at a right end thereof in the left-right direction. The ink tank set 51 is positioned rearward of this opening of the casing 8. A cover 70 is disposed at the casing 8 so as to be located frontward of the opening of the casing 8. The cover 70 is pivotably movable about a pivot axis that is positioned at a lower end of the cover 70 in the up-down direction and that extends in the left-right direction. The cover 70 is pivotable from a covering position illustrated in FIG. 1 for covering the opening of the casing 8 to an exposing position for exposing the opening of the casing 8 to the outside of the multifunction peripheral 10. The tank cover 110 may be omitted.

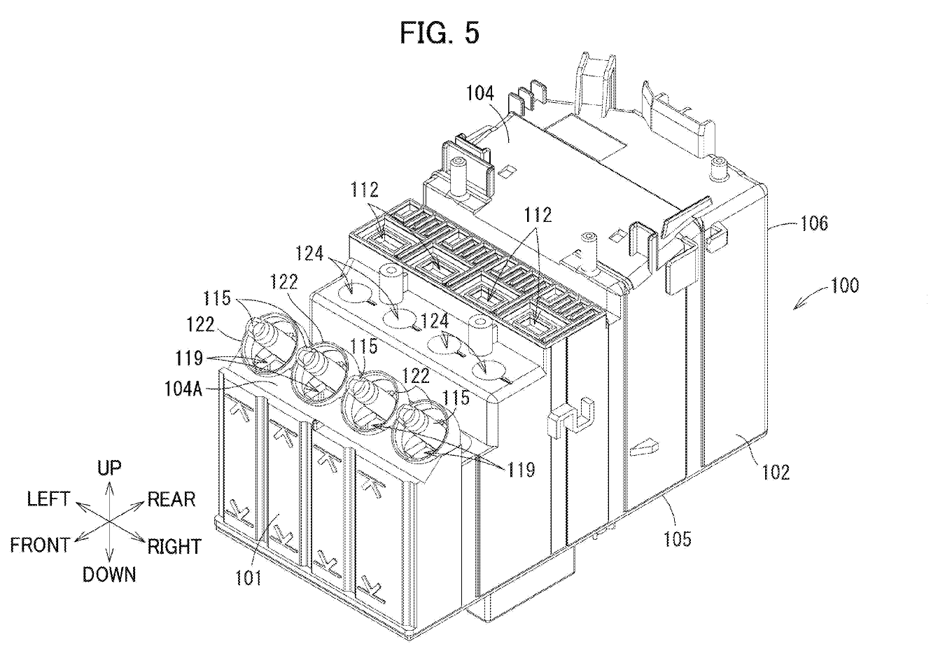

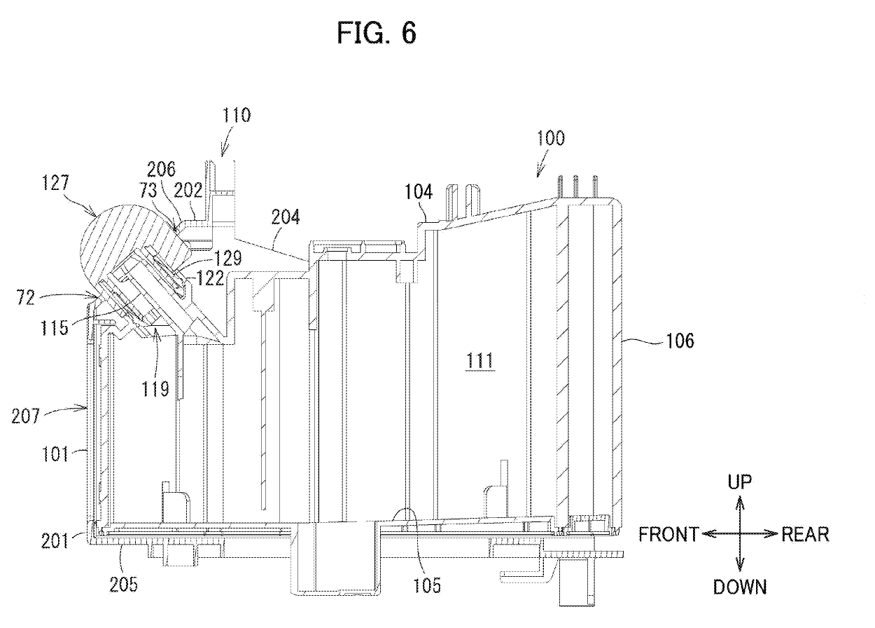

As illustrated in FIGS. 5 and 6, the ink tank 100 has four ink chambers 111 on the inside. Each ink chamber 111 stores ink of one color from among four different colors: black, yellow, cyan, and magenta. Incidentally, in FIG. 6, only one ink chamber 111 is illustrated.

As illustrated in FIGS. 4 and 5, the ink tank 100 has an outer shape of a substantially rectangular parallelepiped. The ink tank 100 includes a front wall 101, a right wall 102, a left wall 103, a top wall 104, a bottom wall 105, and a rear wall 106. The front wall 101, the right wall 102, the left wall 103, the top wall 104, the bottom wall 105, and the rear wall 106 define the ink chambers 111 for storing ink. The ink tank 100 is manufactured, for example, as an integrally-molded product made through injection molding of a resin material. Among the outer walls of the ink tank 100, the bottom wall 105 may be a separately-molded member, for example. The front wall 101, the right wall 102, the left wall 103, the top wall 104, the bottom wall 105, and the rear wall 106 have such translucency that levels of the ink inside the ink tank 100 can be visually recognized from the outside of the ink tank 100.

An upper surface of the top wall 104 is configured by a plurality of surfaces extending in the front-rear direction and the left-right direction. The top wall 104 has air communication ports 112 configured to provide communication between the interior and the exterior of the respective ink chambers 111. Each air communication port 112 extends in the up-down direction through the top wall 104. The upper surface of the top wall 104 has a sloped surface 104A. The sloped surface 104A is positioned at a front end of the upper surface of the top wall 104. The sloped surface 104A is sloped relative to the front-rear direction to extend downward toward the front. The sloped surface 104A is positioned to span between the left and right ends of the ink tank 100.

Outlet tubes 124 are positioned on the top wall 104. Each outlet tube 124 is a circular tube extending downward from the top wall 104 inside the corresponding ink chamber 111. A lower end of each outlet tube 124 is positioned near the bottom wall 105. An opening in an upper end of each outlet tube 124 is at the top wall 104. An ink tube 32 is connected to the upper end of each outlet tube 124. The ink in each ink chamber 111 is to flow into the recording head 39 through the corresponding outlet tube 124 and ink tube 32. As the ink in each ink chamber 111 is consumed by the recording head 39 ejecting the ink, air is to be introduced into the ink chamber 111 through the corresponding air communication port 112.

On the front end portion of the top wall 104, circular-shaped walls 122 are positioned. Each circular-shaped wall 122 has a hollow cylindrical shape and surrounds a tank tube 115 and a communication port 119. Each circular-shaped wall 122 extends from the front end portion of the top wall 104 diagonally frontward and upward in parallel to the corresponding tank tube 115, i.e., in an extending direction crossing the gravitational direction and the horizontal directions. A tip end of each tank tube 115 protrudes further upward relative to a tip end of the corresponding circular-shaped wall 122.

The tank tubes 115 are positioned on the inside of the respective circular-shaped walls 122. Each tank tube 115 is a circular tube extending, from an upper surface of the top wall 104, diagonally frontward and rearward, i.e., in the extending direction crossing the gravitational direction and the horizontal directions. An upper end of each tank tube 115 is open on the outside of the corresponding ink chamber 111. A lower end of each tank tube 115 is open on the inside of the corresponding ink chamber 111. An internal space of each tank tube 115 provides communication between the outside and the inside of the corresponding ink chamber 111. Each tank tube 115 is positioned rearward relative to a center of the corresponding circular-shaped wall 122. In other words, when viewed in the extending direction of each tank tube 115, an axis passing through a center of the tank tube 115 is positioned rearward relative to an axis passing through the center of the corresponding circular-shaped wall 122.

The communication ports 119 are positioned on the inside of the respective circular-shaped walls 122 at the sloped surface 104A. Each communication port 119 extends in the up-down direction through the top wall 104. In each communication port 119, a front portion has a circular-shape and a rear portion has a rectangular shape. That is, each communication port 119 has a rectangular shape whose front side is convex to form an arcuate shape. Each communication port 119 provides communication between the outside and the inside of the corresponding ink chamber 111. Each communication port 119 is positioned frontward of the corresponding tank tube 115. In other words, a straight line passing through the center of each communication port 119 and extending in the extending direction when viewed in the extending direction of the corresponding tank tube 115 is positioned frontward relative to the axis passing through the center of the corresponding tank tube 115 when viewed in the extending direction. Each communication port 119 is positioned downward of the corresponding tank tube 115. Each communication port 119 is positioned frontward relative to the center of the corresponding circular-shaped wall 122. In other words, the straight line passing through the center of each communication port 119 and extending in the extending direction when viewed in the extending direction of the corresponding circular-shaped wall 122 is positioned frontward relative to the axis passing through the center of the corresponding circular-shaped wall 122 when viewed in the extending direction of the corresponding circular-shaped wall 122.

As illustrated in FIG. 4, the tank cover 110 holds the ink tank 100 while covering a front end portion of the ink tank 100 from the front side. The tank cover 110 includes a front wall 201, a top wall 202, a right wall 203, a left wall 204, a bottom wall 205, and a sloped wall 206. The front wall 201 covers the front side of the ink tank 100. The front wall 201 has an opening 207. Through the opening 207, a portion of the front wall 101 of the ink tank 100 is exposed toward the front of the tank cover 110. Incidentally, “a portion of the front wall 101 of the ink tank 100 is exposed toward the front of the tank cover 110 through the opening 207” denotes that a user can at least view a part of the front wall 101 of the ink tank 100 through the opening 207 from the front side of the tank cover 110, and does not imply that a part of the front wall 101 of the ink tank 100 protrudes frontward out of the tank cover 110 through the opening 207.

The top wall 202 covers a part of a frontward portion of the top wall 104 of the ink tank 100. The right wall 203 covers a part of the right wall 102 of the ink tank 100. The left wall 204 covers a part of the left wall 103 of the ink tank 100. The bottom wall 205 covers the bottom wall 105 of the ink tank 100.

The sloped wall 206 is connected to an upper end of the front wall 201, and is connected to a front end of the top wall 202. The sloped wall 206 is positioned upward of the circular-shaped walls 122 of the ink tank 100. The sloped wall 206 is positioned frontward of the circular-shaped walls 122 of the ink tank 100. That is, the sloped wall 206 is positioned, relative to the circular-shaped walls 122, in a direction aligned with the extending direction of the circular-shaped walls 122 from the front end portion of the top wall 104. The sloped wall 206 has an outer surface crossing the gravitational direction and horizontal directions. The outer surface of the rear wall 106 is sloped relative to the front-rear direction to extend downward toward the front. The sloped wall 206 covers a part of the sloped surface 104A of the top wall 104 of the ink tank 100.

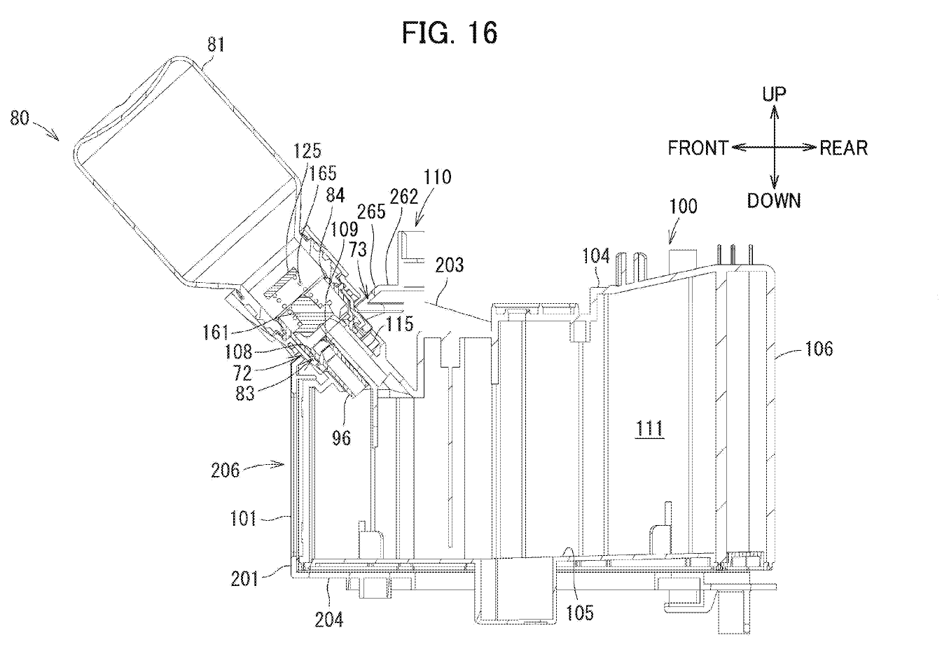

The sloped wall 206 has four through-holes 72 arranged at intervals in the left-right direction. Each through-hole 72 extends through the sloped wall 206 in the up-down direction. An inner peripheral surface of each through-hole 72 has a cylindrical shape extending in a direction orthogonal to the outer surface of the sloped wall 206, i.e., diagonally upward and frontward. That is, each through-hole 72 is cylindrical in shape. Here, the cylindrical in shape denotes a shape whose inner peripheral surface extends circumferentially to form a closed space therein, and does not necessarily mean that the inner peripheral surface forms an opening of a circular shape. Further, each through-hole 72 is cylindrical in shape regardless of the length of the inner peripheral surface extending in a direction in which the opening defined by the inner peripheral surface is facing, in other words, regardless of the thickness of each through-hole 72. The inner peripheral surface of each through-hole 72 surrounds the corresponding circular-shaped wall 122 when viewed from diagonally upward and frontward. The four through-holes 72 are arranged to correspond to the respective ink chambers 111. In other words, each of the four through-holes 72 overlaps corresponding one of the four ink chambers 111 when viewed from diagonally upward and frontward. Each circular-shaped wall 122 of the ink tank 100 is exposed to the outside of the tank cover 110 through the corresponding through-hole 72. As illustrated in FIG. 16, the tank tube 115 protrudes outward of the tank cover 110 through the corresponding through-hole 72.

Each through-hole 72 has a circular shape on the front side and a rectangular shape on the rear side. In other words, each through-hole 72 has a rectangular shape whose front side is convex to form an arcuate shape. A slit 73 extends rearward from the corresponding through-hole 72 and is in communication with the same. The slit 73 in communication with the corresponding through-hole 72 is positioned at a center of the corresponding through-hole 72 in the left-right direction.

As illustrated in FIG. 4, in each through-hole 72, key grooves 74 are positioned selectively on the left and right sides of the slit 73. Among the four through-holes 72, presence/absence, positions and shapes of the key grooves 74 are different. Specifically, in the through-hole 72 positioned on the far left in FIG. 4, one key groove 74 is positioned on the right side of the slit 73, and another key groove 74 is positioned on the left side of the slit 73. A distance in the left-right direction between the key groove 74 on the right and the slit 73 is the same as a distance in the left-right direction between the key groove 74 on the left and the slit 73.

In the through-hole 72 positioned second from the left in FIG. 4, one key groove 74 is positioned on the right side of the slit 73, and another key groove 74 is positioned on the left side of the slit 73. A distance in the left-right direction between the key groove 74 on the right and the slit 73 is greater than a distance in the left-right direction between the key groove 74 on the left and the slit 73.

In the through-hole 72 positioned third from the left in FIG. 4, one key groove 74 is positioned on the right side of the slit 73, but no key groove 74 is positioned on the left side of the slit 73. A length in the left-right direction of the key groove 74 on the right is greater than a length in the left-right direction of each key groove 74 in the second through-hole 72 from the left.

In the through-hole 72 positioned on the far right in FIG. 4, one key groove 74 is positioned on the right side of the slit 73, and another key groove 74 is positioned on the left side of the slit 73. A distance in the left-right direction between the key groove 74 on the right and the slit 73 is smaller than a distance in the left-right direction between the key groove 74 on the left and the slit 73.

As illustrated in FIG. 6, each tank cap 127 is detachable from and attachable to the corresponding circular-shaped wall 122. The tank cap 127 is a cylindrical-shaped member whose one end is closed. The tank cap 127 has such an outer shape that the tank cap 127 is set to an attached posture by a part of the tank cap 127 being fitted in the corresponding slit 73 of the tank cover 110. In a state where the tank caps 127 are detached from the respective circular-shaped walls 122, the tank caps 127 are disconnected from the ink tank 100 and tank cover 110 and are completely separated from the ink tank 100 and tank cover 110. That is, the ink tank set 51 does not include any retaining members, such as arms, for keeping the tank caps 127 connected to the ink tank 100 or the ink tank 100 after the tank caps 127 are detached from the respective circular-shaped walls 122.

### Liquid Bottle 80

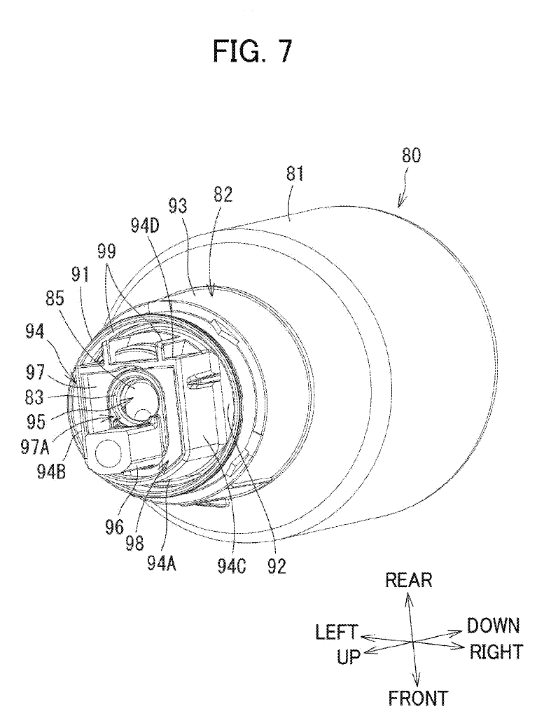

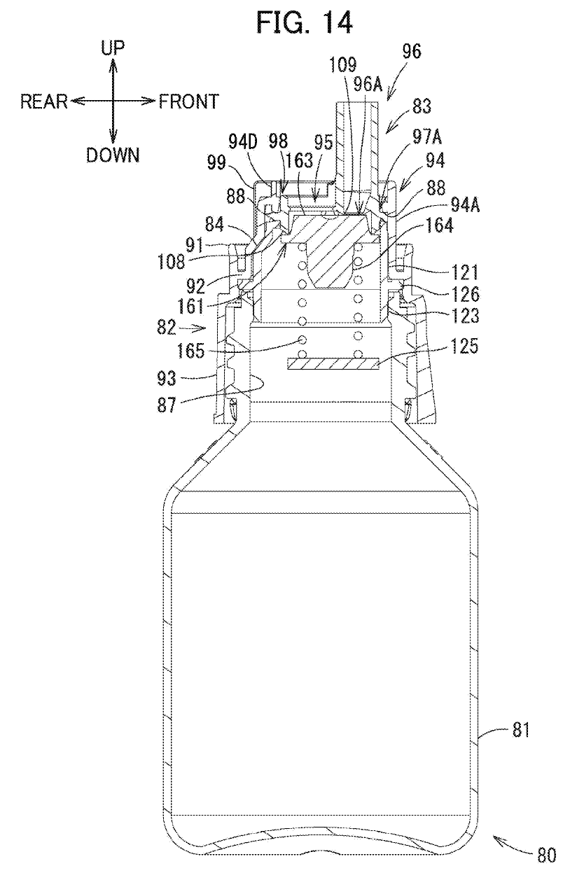

A liquid bottle 80 illustrated in FIG. 7 is to be connected to the ink tank set 51. As illustrated in FIGS. 7 and 14, each liquid bottle 80 includes a bottle body 81, a bottle cap 82, a rubber 83, a support member 84, and a valve 161. The bottle body 81 is cylindrical in shape and has an upper end portion serving as a neck part 87. The neck part 87 has a diameter smaller than a diameter of a lower portion of the bottle body 81. Attachment of the bottle cap 82 to the neck part 87 provides a container having an interior space in which ink is configured to be stored. The bottle body 81 and the bottle cap 82 are an example of a body of the disclosure.

The bottle cap 82 includes a side wall 93, a bottom wall 92, a protrusion 94, an opening 95, a bottle tube 96, key members 99, and an annular rib 91. The side wall 93 is a cylindrical shaped wall extending in the up-down direction. The side wall 93 is threadingly connected to the neck part 87. The bottom wall 92 is a circular ring-shaped wall extending radially inward from an upper end of the side wall 93.

The protrusion 94 is a tubular-shaped wall extending upward from the bottom wall 92. The protrusion 94 can be inserted into the corresponding through-hole 72 of the tank cover 110. The protrusion 94 has an outer peripheral surface whose shape conforms to the shape of the inner peripheral surface of the corresponding through-hole 72 of the tank cover 110. In other words, the outer peripheral surface of the protrusion 94 has a shape and a size substantially equal to a shape and a size of the inner peripheral surface of the corresponding through-hole 72 of the tank cover 110. That is, the outer peripheral surface of the protrusion 94 has such a shape whose front side is curved to form an arc and whose rear side has a rectangular shape constituted by straight lines. Put differently, the outer peripheral surface of the protrusion 94 has a rectangular shape whose front side is convex toward the front to form an arcuate shape. The protrusion 94 is an example of a part of the body of the disclosure.

Specifically, the outer peripheral surface of the protrusion 94 includes an outer curved surface 94A, a left outer flat surface 94B, a right outer flat surface 94C, and a rear outer flat surface 94D. The outer curved surface 94A is convex toward the front. The left outer flat surface 94B is connected to a left end of the outer curved surface 94A. The right outer flat surface 94C is connected to a right end of the outer curved surface 94A. The rear outer flat surface 94D connects a rear end of the left outer flat surface 94B to a rear end of the right outer flat surface 94C. The outer curved surface 94A matches the inner curved surface 72A of the corresponding through-hole 72 in a state where the protrusion 94 is inserted in the corresponding through-hole 72. The left outer flat surface 94B matches the right inner flat surface 72C of the corresponding through-hole 72 in the state where the protrusion 94 is inserted in the corresponding through-hole 72. The right outer flat surface 94C matches the left inner flat surface 72B of the corresponding through-hole 72 in the state where the protrusion 94 is inserted in the corresponding through-hole 72. The rear outer flat surface 94D is at such a position that an aperture 95 described later and the bottle tube 96 are interposed between the outer curved surface 94A and the rear outer flat surface 94D in the front-rear direction. The rear outer flat surface 94D matches the rear inner flat surface 72D of the corresponding through-hole 72 in the state where the protrusion 94 is inserted in the corresponding through-hole 72.

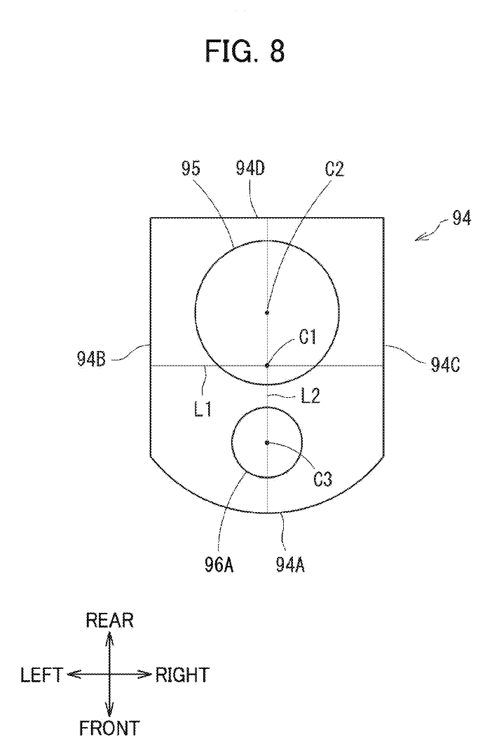

As illustrated in FIG. 8, the outer peripheral surface of the protrusion 94 is not rotationally symmetric about a center C1 of the protrusion 94. Here, being rotationally symmetric denotes that an object overlaps itself more than twice when the object is rotated at 360 degrees about the center of the same. For example, if the outer peripheral surface of the protrusion 94 is equilateral triangular, the outer peripheral surface of the protrusion 94 is rotationally symmetric about the center C1 of the protrusion 94, since the protrusion 94 overlaps itself three times when the protrusion 94 is rotated 360 degrees about the center C1 of the protrusion 94. In the present embodiment, since the protrusion 94 overlaps itself only once when the protrusion 94 is rotated 360 degrees about the center C1 of the same, the outer peripheral surface of the protrusion 94 is not rotationally symmetric about the center C1. Accordingly, the orientation of the protrusion 94 in which the protrusion 94 can be inserted into the through-hole 72 is determined to be one. The center C1 is a point where, when the protrusion 94 is viewed from above, a midpoint of a line segment L1 connecting the left outer flat surface 94B to the right outer flat surface 94C coincides with a midpoint of a line segment L2 connecting the front end of the outer curved surface 94A to the rear outer flat surface 94D.

As illustrated in FIG. 7, the protrusion 94 includes a top wall 97 positioned at an upper end portion thereof. The top wall 97 is positioned slightly below an upper end of the top wall 97. The top wall 97 has an upper surface orthogonal to the up-down direction. the top wall 97 is flat plate shaped extending in the front-rear direction and left-right direction. The upper surface of the top wall 97 and an inner peripheral surface of the protrusion 94 define a recessed portion 98. The recessed portion 98 has an inner peripheral surface in parallel to the outer peripheral surface of the protrusion 94.

The key members 99 extend rearward from the rear outer flat surface 94D of the outer peripheral surface of the protrusion 94. Positions and shapes of the key members 99 match the positions and shapes of the corresponding through-hole 72 to which the liquid bottle 80 is to be connected. In other words, among the four liquid bottles 80 storing ink of respective colors of black, yellow, cyan and magenta, the positions and shapes of the key members 99 relative to the respective rear outer flat surfaces 94D are mutually different. In FIG. 7, the key members 99 of the liquid bottle 80 designed to match the leftmost through-hole 72 of the tank cover 110 are illustrated.

On the upper surface of the top wall 97 of the protrusion 94, an opening 97A elongated in the front-rear direction is positioned. Through the opening 97A, a part of the rubber 83 is exposed to the outside.

The annular rib 91 is positioned on an outer periphery of the upper surface of the bottom wall 92. The annular rib 91 is positioned outward of and spaced apart from the protrusion 94. The annular rib 91 protrudes upward from the upper surface of the bottom wall 92. The annular rib 91 extends to form a circular annular shape along the outer periphery of the upper surface of the bottom wall 92. The annular rib 91 surrounds the outer peripheral surface of the protrusion 94. With this arrangement, an ink retaining space of a circular ring shape is defined by an inner peripheral surface of the annular rib 91, the outer peripheral surface of the protrusion 94, and the upper surface of the bottom wall 92.

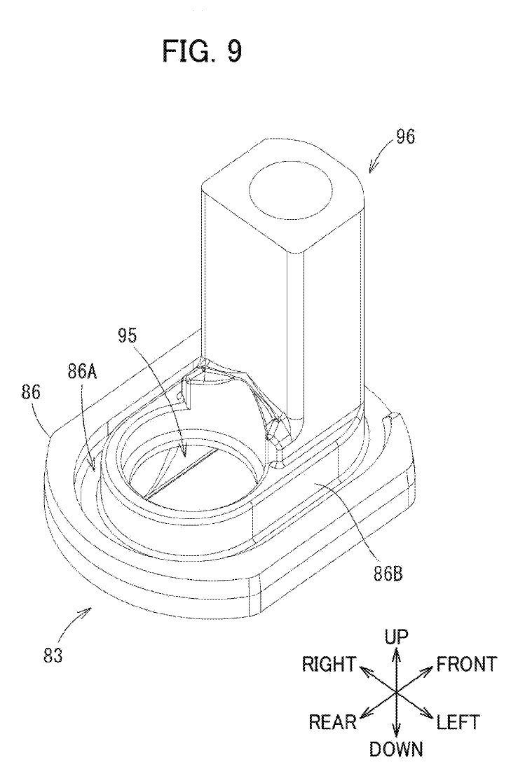

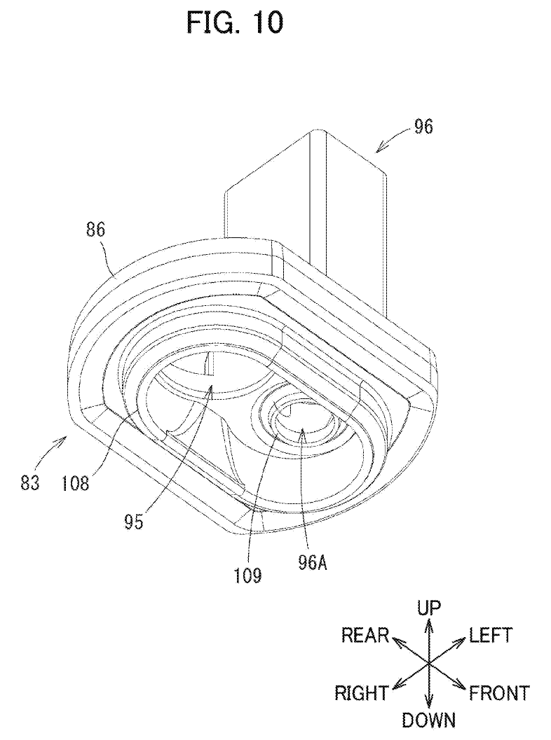

As illustrated in FIG. 14, the rubber 83 is positioned on the inside of the protrusion 94 of the bottle cap 82. As illustrated in FIGS. 9 and 10, the rubber 83 has a base part 86, the opening 95, and the bottle tube 96. The base part 86 has an oval shape whose front and rear ends are arcuate and whose left and right ends extend linearly in the left-right direction. On an upper surface of the base part 86, a groove 86A is positioned. The groove 86A extends to form an oval shape along the periphery of the base part 86. The groove 86A is recessed downward from the upper surface of the base part 86. In the groove 86A, a protrusion 88 positioned on the lower surface of the top wall 97 of the bottle cap 82 is fitted. The bottle tube 96 is an example of a nozzle of the disclosure.

A protrusion 86B protruding upward is disposed on the inside of the groove 86A. The protrusion 86B has an oval shape whose front and rear ends are arcuate and whose left and right ends extend linearly in the front-rear direction. The protrusion 86B is received in the opening 97A of the bottle cap 82.

The opening 95 is circular in shape, and extends through the protrusion 86B in the up-down direction. The opening 95 connects the interior space of the liquid bottle 80 to the outside. The opening 95 is an example of a second opening of the disclosure.

The bottle tube 96 is positioned frontward of the opening 95. The base part 86 extends upward from the protrusion 86B. The bottle tube 96 is a hollow cylindrical member that is open upward and downward. The bottle tube 96 has an interior space that connects the interior space of the liquid bottle 80 to the outside. The bottle tube 96 has a polygonal-shaped outer profile that conforms to the shape of the corresponding communication port 119 of the ink tank 100. That is, the outer profile of the bottle tube 96 is such that a front side thereof is circular and a rear side thereof is rectangular. In other words, the outer profile of the bottle tube 96 is in such a shape that a front side of a rectangle is convex to form an arcuate shape. The interior space of the bottle tube 96 is circular in cross-section. Since the rear end portion of the bottle tube 96 is rectangular, a thickness of each corner of the bottle tube 96 is thicker than a thickness of a front end portion of the bottle tube 96. As such, the bottle tube 96 is less likely to deform toward the rear. An opening 96A defining the bottom of the internal space of the bottle tube 96 is an example of a first opening of the disclosure. The opening 96A is an opening independent of the opening 95. That is, the opening 95 and the opening 96A are not continuous with each other, as a space, in the front-rear direction.

As illustrated in FIG. 8, the opening 95 is positioned rearward of the center C1 of the protrusion 94. The opening 96A of the bottle tube 96 is positioned frontward of the center C1 of the protrusion 94. The outer peripheral surface of the protrusion 94 is not rotationally symmetric about a center C2 of the opening 95. The outer peripheral surface of the protrusion 94 is not rotationally symmetric about a center C3 of the opening 96A.

As illustrated in FIG. 10, the base part 86 has a bottom surface on which a lip 108 and a lip 109 are positioned. The lip 108 and the lip 109 are parts providing a tight-sealing and are deformable fitting protrusions. The lip 108 extends downward in the up-down direction from the bottom surface of the base part 86. The lip 108 has an annular shape whose first dimension in the front-rear direction (an example of a first direction of the disclosure) is greater than a second dimension thereof in the left-right direction (an example of a second direction of the disclosure). Specifically, the lip 108 has an oval shape whose front and rear ends are arcuate in shape and whose left and right ends extend linearly in the front-rear direction. The opening 95 and the opening 96A are positioned inward of the lip 108. In other words, the lip 108 is positioned around the opening 95 and the opening 96A, i.e., to surround the opening 95 and the opening 96A. The lip 108 is in contact with the valve 161 and deforms to provide a liquid-tight sealing in cooperation with the valve 161. The lip 108 is an example of a first lip of the disclosure.

The lip 109 extends downward in the up-down direction from the bottom surface of the protrusion 86B along the periphery of the opening 96A. The lip 109 is positioned on the inside of the lip 109. The lip 109 is circular in shape. The lip 109 has a bottom end positioned upward of a bottom end of the lip 108. The lip 109 is in contact with the valve 161 and deforms to provide a liquid-tight sealing in cooperation with the valve 161. The lip 109 is an example of a second lip of the disclosure.

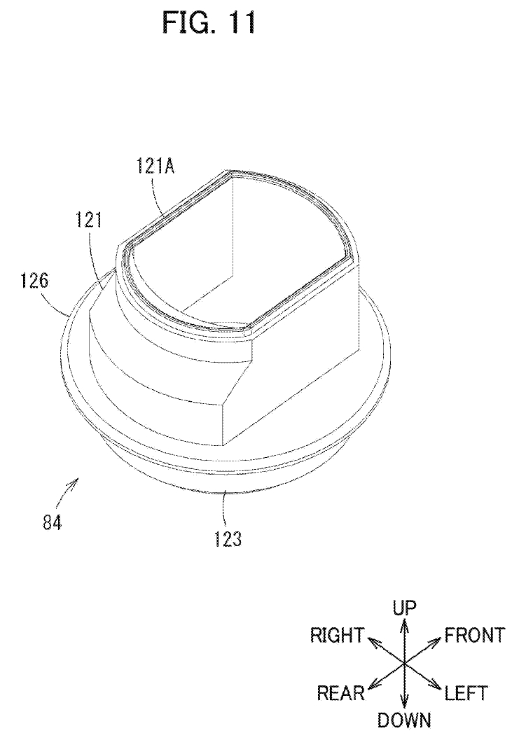

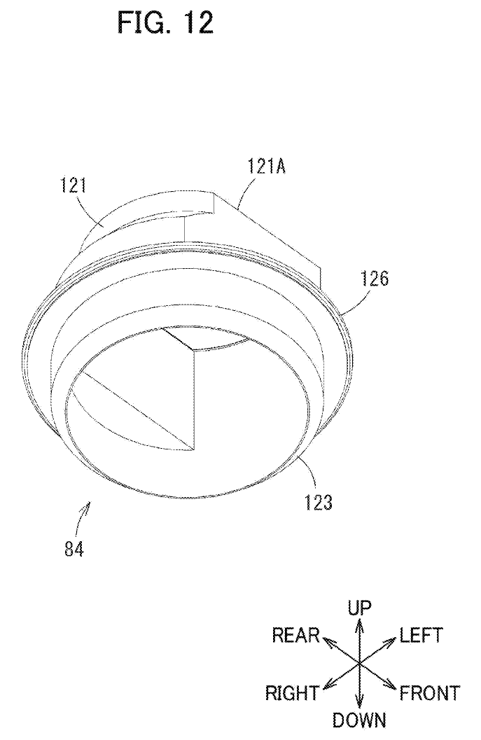

As illustrated in FIGS. 11, 12 and 14, the support member 84 is positioned in the interior space of the bottle body 81 and on the inside of the protrusion 94 of the bottle cap 82. The support member 84 has an upper portion 121, a flange 126, and a lower portion 123.

The upper portion 121 is a tubular member having an oval shape. The upper portion 121 is positioned on the inside of the protrusion 94 of the bottle cap 82. The upper portion 121 has an upper end face 121A in contact with the bottom surface of the rubber 83 at a position outward of the lip 108. The upper end face 121A has a shape generally the same as the outer shape of the base part 86 of the rubber 83. Further, the shape of the upper end face 121A is generally the same as the oval shape of the lip 108. The rubber 83 is nipped between the top wall 97 of the protrusion 94 of the bottle cap 82 and the upper portion 121 of the support member 84 in the up-down direction. The lip 108 of the rubber 83 is positioned on the inside of the upper portion 121 and is in contact with the upper portion 121. In other words, the upper portion 121 is in contact with the lip 108 from the outside.

The flange 126 is a circular plate extending outward from a bottom end of an outer peripheral surface of the upper portion 121. The flange 126 does not protrude toward the interior space of the upper portion 121. The flange 126 has an outer diameter greater than the neck part 87 of the bottle body 81 and smaller than the inner diameter of the side wall 93 of the bottle cap 82. The flange 126 is in contact with the upper surface of the neck part 87 of the bottle body 81 and is nipped between the upper surface of the neck part 87 of the bottle body 81 and the bottom wall 92 of the bottle cap 82.

The lower portion 123 has a hollow cylindrical shape extending downward from the flange 126. The lower portion 123 has an outer diameter smaller than the inner diameter of the side wall 93 of the bottle cap 82. The outer diameter of the lower portion 123 is smaller than the neck part 87 of the bottle body 81.

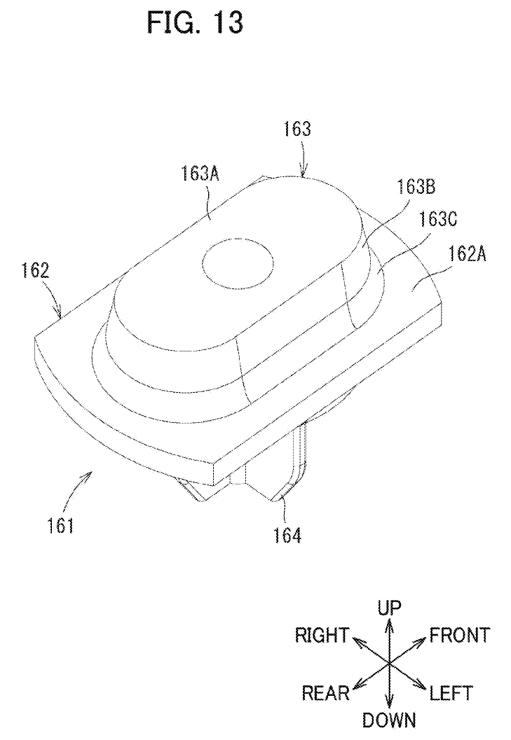

As illustrated in FIGS. 13 and 14, the valve 161 is positioned in the interior space of the protrusion 94. The valve 161 has a flat portion 162, a protruding portion 163, and a spring seat 164. The flat portion 162 is a flat plate having an oval outer shape. The flat portion 162 has a planar upper surface 162A. The flat portion 162 can be displaced to a position inside the upper portion 121 of the support member 84. In a state where the flat portion 162 is positioned inside the upper portion 121 of the support member 84, the valve 161 can move in the up-down direction while being guided by the support member 84. The spring seat 164 is positioned on a lower surface of the flat portion 162.

The protruding portion 163 is positioned on the upper surface 162A of the flat portion 162. The upper surface 162A is positioned around the protruding portion 163. The protruding portion 163 protrudes upward from the upper surface 162A. The protruding portion 163 is tapered toward the top such that a transverse cross-sectional area thereof in the front-rear and left-right directions gradually decreases toward the top. The protruding portion 163 has an upper surface 163A, a side surface 163B, and a curved surface 163C.

The upper surface 163A of the protruding portion 163 is smaller than the upper surface 162A of the flat portion 162. The upper surface 163A has an oval shape similar to the outer shape of the lip 108 of the rubber 83. The upper surface 163A has an outer shape smaller than the outer shape of the inner surface of the lip 108. The upper surface 163A can contact the lip 109 of the rubber 83. The side surface 163B extends downward from an outer periphery of the upper surface 163A. The curved surface 163C connects a bottom end of the side surface 163B to the upper surface 162A of the flat portion 162. The curved surface 163C faces diagonally upward and is recessed downward. The protruding portion 163 can be displaced to a position inside the lip 108 of the rubber 83. The protruding portion 163 can contact the lip 108 of the rubber 83. In a state where the curved surface 163C is in contact with the lip 108, the upper surface 163A can contact the lip 109 of the rubber 83.

As illustrated in FIG. 14, a spring seat 125 is positioned below the support member 84 in the interior of the bottle body 81. The spring seat 125 is fixed, for example, to the bottle body 81 or to the support member 84. A coil spring 165 is positioned between the valve 161 and the spring seat 125. The coil spring 165 urges the valve 161 upward. The coil spring 165 is an example of a resilient member of the disclosure. The up-down direction is an example of an urging direction of the disclosure.

The valve 161 is movable in the up-down direction between a closing position and an opening position. As illustrated in FIG. 14, the upper surface 163A of the protruding portion 163 is in contact with the lip 109 when the valve 161 is in the closing position. Hence, ink does not flow into the interior of the bottle tube 96. Further, the lip 108 is in contact with the curved surface 163C of the protruding portion 163. Hence, ink is less likely to flow into the interior of the lip 108 of the rubber 83. Further, since the protruding portion 163 is positioned on the inside of the lip 108 in the closing position, the lip 108 is restricted from deforming inward. Incidentally, since the upper portion 121 of the support member 84 is positioned on the outside of the lip 108, the lip 108 is also restricted from deforming outward.

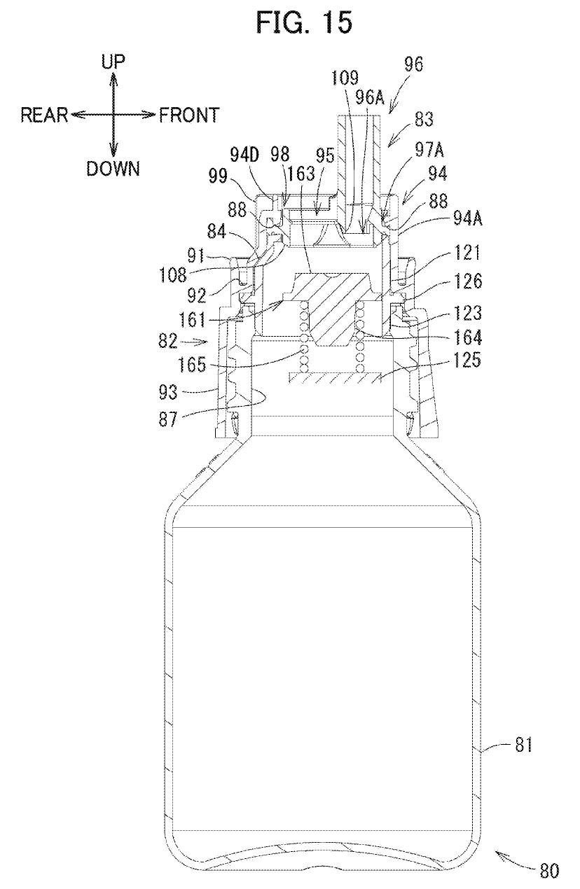

As illustrated in FIG. 15, in the opening position, the valve 161 is displaced downward against an urging force of the coil spring 165. When the valve 161 is in the opening position, the protruding portion 163 of the valve 161 is positioned below the lip 108 of the rubber 83. Hence, the upper surface 163A of the protruding portion 163 is spaced apart from the lip 109, and the curved surface 163C of the protruding portion 163 is spaced apart from the lip 108. A space between the valve 161 and the rubber 83 becomes an air flow path and an ink flow path.

### Connection of the Liquid Bottle 80 to the Ink Tank 100

A user first confirms in which orientation the protrusion 94 of the liquid bottle 80 be placed so that the protrusion 94 can be inserted into the leftmost through-hole 72 of the tank cover 110. At this time, the user can easily recognize the orientation of the protrusion 94 to be inserted into the through-hole 72, since the outer curved surface 94A and the rear outer flat surface 94D of the protrusion 94 are arranged to interpose therebetween the opening 95 and the bottle tube 96.

Next, the user inserts the protrusion 94 into the leftmost through-hole 72. At this time, the key members 99 are inserted into the key grooves 74 of the through-hole 72. Incidentally, the key members 99 do not enter the key grooves 74 even when the user erroneously attempts to insert the protrusion 94 into the second through-hole 72 from the left, thereby restricting incorrect connection of the liquid bottle 80.

At the same time as the key members 99 enter the key grooves 74, the bottle tube 96 is inserted into the communication port 119 of the tank cover 110 and the tank tube 115 is inserted into the opening 95 of the liquid bottle 80. At this time, the valve 161 is pressed diagonally upward by the tank tube 115, moving to the opening position from the closing position against the urging force of the coil spring 165. The liquid bottle 80 is thus connected to the ink tank 100.

As illustrated in FIG. 16, the bottle tube 96 is positioned below the tank tube 115 in a state where the liquid bottle 80 is connected to the ink tank 100. The air flow path including the internal space of the tank tube 115 is positioned above the ink flow path including the internal space of the bottle tube 96. The outer curved surface 94A on the outer peripheral surface of the protrusion 94 is supported by the inner curved surface 72A on the inner peripheral surface of the through-hole 72.

In the state where the liquid bottle 80 is connected to the ink tank 100, the ink stored in the liquid bottle 80 flows into the ink chamber 111 through the internal space of the bottle tube 96. Also, while the ink flows, air flows into the ink chamber 111 through the internal space of the air communication port 112 and then flows into the liquid bottle 80 through the tank tube 115. In this way, so-called air-liquid substitution occurs, and the ink in the liquid bottle 80 is supplied to the ink chamber 111.

### Operations and Advantages of the Embodiment

In a state where the curved surface 163C of the protruding portion 163 is in contact with the lip 108 of the rubber 83 while the valve 161 is at the closing position, the protruding portion 163 is positioned on the inside of the lip 108. Hence, the lip 108 is restricted from deforming to bend inward, thereby providing liquid-tight sealing to the opening 95. Further, the protruding portion 163 is positioned on the inside of the lip 108. This configuration can reduce a volume of a space in which ink can be accumulated on the inside of the lip 108.

Further, the protruding portion 163 is configured to contact on the inside of the linear portions of the lip 108 which are relatively susceptible to deformation, thereby restricting the linear portions of the lip 108 from bending inward.

Further, since the upper portion 121 of the support member 84 is in contact with the lip 108 on the outside of the lip 108, the lip 108 is restricted from bending outward. In particular, since the upper portion 121 of the support member 84 is in contact with the linear portions of the lip 108 which are relatively susceptible to deformation, the linear portions of the lip 108 are restricted from bending outward.

Further, since the protruding portion 163 of the valve 161 is tapered toward its protruding end, the protruding portion 163 is less likely to contact the lip 108 when entering the interior of the lip 108.

Further, the lip 109 of the rubber 83 and the upper surface 163A of the protruding portion 163 of the valve 161 are configured to contact each other, thereby restricting ink accumulated in the internal space of the ink bottle 80 from flowing out through the bottle tube 96.

Further, the protrusion 94 of the bottle cap 82 has linear portions and curved portions and is not rotationally symmetric about the center C2 of the circular opening 95 and the center C3 of the circular opening 96A. Accordingly, positions of the opening 95 and opening 96A can be determined based on the outer shape of the protrusion 94.

### Variations

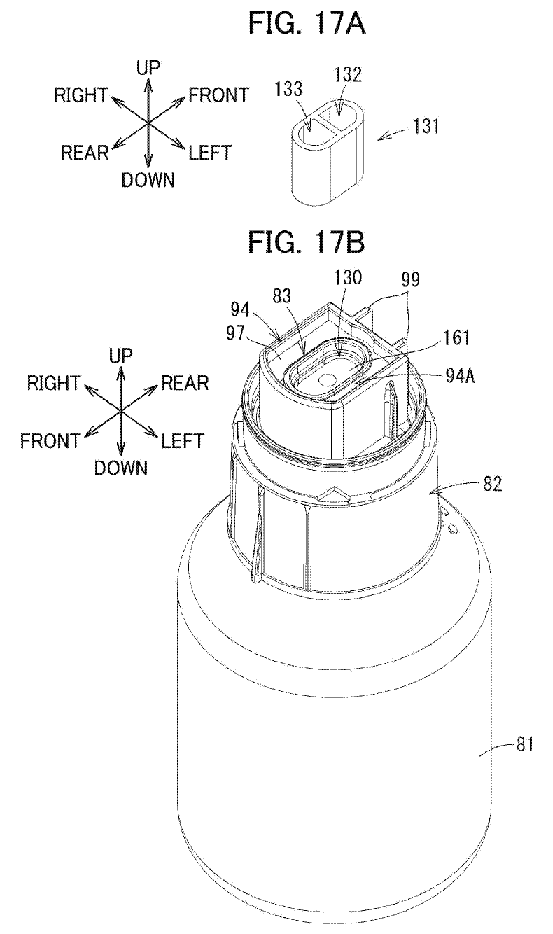

In the above-described embodiment, two openings, namely, the opening 95 and the opening 96A, are positioned in the rubber 83 of the liquid bottle 80. However, only one opening may be positioned in the rubber 83. For example, as illustrated in FIG. 17B, the rubber 83 may have a single opening 130, instead of the opening 95 and the bottle tube 96. The opening 130 has an oval shape, just like the opening 97A of the bottle cap 82, and is slightly smaller in size than the opening 97A. In this case, as illustrated in FIG. 17A, instead of the tank tube 115 and the communication port 119, a tank tube 131 is positioned inside each circular-shaped wall 122 in the ink tank 100. The tank tube 131 has an oval outer shape, like the opening 130. The opening 130 has two fluid paths 132 and 133. By the tank tube 131 entering the opening 130, the internal space of the liquid bottle 80 and the ink chamber 111 are to be communicated with each other through the two fluid paths 132 and 133.

In the above-described embodiment, the bottle tube 96 of the liquid bottle 80 is inserted into the communication port 119 of the ink tank 100 and the tank tube 115 of the ink tank 100 is inserted into the opening 95 of the liquid bottle 80. Alternatively, the liquid bottle 80 may have two tubes, whereas the ink tank 100 may have two openings into which the two tubes are to be inserted respectively. Still alternatively, the ink tank 100 may have two tubes, whereas the liquid bottle 80 may have two openings into which the two tubes are to be inserted respectively. In this case, the bottle cap 82 may have two openings 97A, rather than one opening 97A.

The lips 108 and 109 of the rubber 83 extend downward from the bottom surface of the base part 86 in the up-down direction. Alternatively, the lip 108 or the lip 109 may extend from the bottom surface of the base part 86 diagonally downward so as to cross the up-down direction. Alternatively, the lip 109 may be omitted.

The protruding portion 163 of the valve 161 may not have a tapered shape. Alternatively, the lip 108 of the rubber 83 may be in contact with the valve 161 at a position other than on the curved surface 163C, for example, on the upper surface 162A of the flat portion 162, or on both the curved surface 163C and the upper surface 162A.

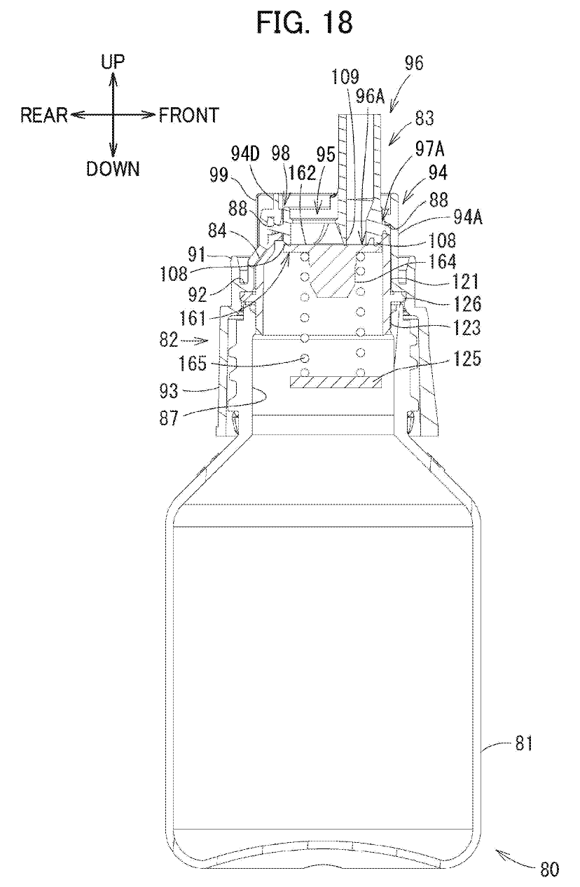

Further, the valve 161 may not have the protruding portion 163. In this case, as illustrated in FIG. 18, only the upper surface 162A of the flat portion 162 constitutes the upper surface of the valve 161. The bottom end of the lip 109 of the rubber 83 is at the same position as the bottom end of the lip 108. Accordingly, when the valve 161 is in the closing position, the upper surface 162A of the flat portion 162 is in contact with both the bottom end of the lip 108 and the bottom end of the lip 109.

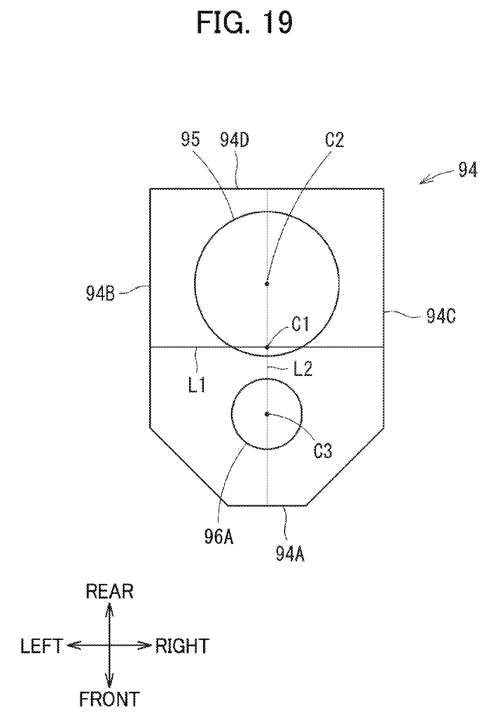

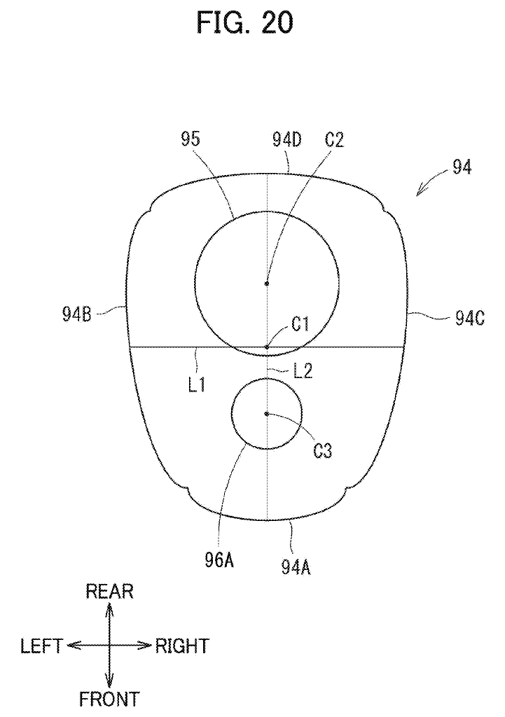

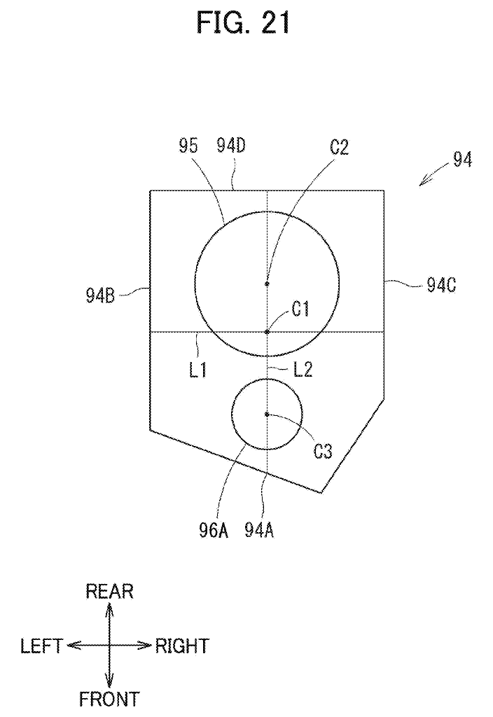

The outer peripheral surface of the protrusion 94 has a rectangular shape whose one side on the front is convex toward the front to form an arcuate shape. However, the outer peripheral surface of the protrusion 94 may have other shapes, provided that the outer peripheral surface of the protrusion 94 is not rotationally symmetric about the center C3 of the circular opening 96A. For example, as illustrated in FIG. 19, the outer curved surface 94A may be configured of three flat surfaces. Alternatively, as illustrated in FIG. 20, the left outer flat surface 94B may be a curved surface convex toward the left; the right outer flat surface 94C may be a curved surface convex toward the right; and the rear outer flat surface 94D may be a curved surface convex toward the rear. In this case, the left outer flat surface 94B is such a curved surface that its rear end is positioned further leftward than its front end. The right outer flat surface 94C is such a curved surface that its rear end is positioned further rightward than its front end. Still alternatively, the outer peripheral surface of the protrusion 94 may have a polygonal shape in which each side may have different lengths. For example, as illustrated in FIG. 21, the outer curved surface 94A may be configured of two flat surfaces. Line segments constituting the two flat surfaces of the outer curved surface 94A, the left outer flat surface 94B, the right outer flat surface 94C, and the rear outer flat surface 94D may have different lengths from each other. Likewise, the inner peripheral surface of the corresponding through-hole 72 of the ink tank set 51 may have such a shape that conforms to the shape of the outer peripheral surface of the protrusion 94 of the liquid bottle 80 to be inserted into the through-hole 72.

What is claimed is:

1. A liquid bottle comprising:
a body having an internal space, the body having an opening allowing the internal space to communicate with an outside of the body through the opening;
a rubber positioned at the opening of the body, the rubber having a first lip extending into the internal space around the opening;
a valve configured to contact the first lip; and
a resilient member urging the valve toward the rubber,
wherein the first lip has an annular shape having a first length in a first direction and a second length in a second direction orthogonal to the first direction, the first length being longer than the second length, and
wherein the valve has a flat portion and a protruding portion, the flat portion opposing the first lip in an urging direction of the resilient member, the protruding portion protruding from the flat portion and being configured to be located inward of the first lip.

2. The liquid bottle according to claim 1,
wherein the first lip has a linear portion extending in the first direction.

3. The liquid bottle according to claim 2,
wherein the protruding portion is configured to contact an inner surface of the linear portion.

4. The liquid bottle according to claim 3, further comprising a support member positioned in the internal space of the body, the support member being in contact with the rubber at a position outside the first lip.

5. The liquid bottle according to claim 4,
wherein the support member is in contact with an outer surface of the linear portion.

6. The liquid bottle according to claim 1,
wherein the protruding portion has a curved surface connected to the flat portion, and
wherein both the flat portion and the curved surface are configured to contact the first lip.

7. The liquid bottle according to claim 1,
wherein the protruding portion protrudes in a protruding direction to have a protruding end in the protruding direction, the protruding portion having a tapered shape whose transverse cross-sectional area decreases toward the protruding end.

8. The liquid bottle according to claim 1,
wherein the opening comprises a first opening and a second opening independent of each other.

9. The liquid bottle according to claim 8, further comprising a nozzle defining an internal space therein, the nozzle having a nozzle opening in communication with the internal space of the nozzle,
wherein the first opening is the nozzle opening of the nozzle.

10. The liquid bottle according to claim 9,
wherein the first lip is positioned to surround the first opening and the second opening,
wherein the rubber further has a second lip extending into the internal space of the body from the first opening, and
wherein the valve is in contact with the second lip in a state where the valve is in contact with the first lip.

11. The liquid bottle according to claim 10,
wherein the second lip extends in the urging direction of the resilient member.

12. The liquid bottle according to claim 10,
wherein the protruding portion of the valve is configured to contact the second lip.

13. The liquid bottle according to claim 5,
wherein the body has a part in which the opening is positioned, the part of the body having an outer shape including a straight line and a curved line, the outer shape of the part of the body being not rotationally symmetric about a center of the opening.

14. A liquid bottle comprising:
a body having an internal space, the body having a first opening allowing the internal space to communicate with an outside of the body through the first opening;
a rubber positioned at the first opening of the body, the rubber having:
a first lip extending into the internal space around the first opening; and
a second lip positioned inward of the first lip, the second lip extending into the internal space around the first opening;
a valve configured to contact the first lip and the second lip; and
a resilient member urging the valve toward the rubber,
wherein the first lip has an annular shape having a first length in a first direction and a second length in a second direction orthogonal to the first direction, the first length being longer than the second length.

15. The liquid bottle according to claim 14,
wherein the body has a second opening allowing the internal space to communicate with the outside of the body through the second opening, and
wherein the first lip is positioned to surround both the first opening and the second opening.
